(19) United States
(12) Patent Application Publication
(10) Pub. No.: US 2021/0396943 A1
(43) Pub. Date: Dec. 23, 2021

(54) OPTICAL MODULE AND METHOD OF MANUFACTURING THE SAME

(71) Applicant: SANWA DENKI KOGYO CO., LTD., Tokyo (JP)

(72) Inventors: Masahiko NAMIWAKA, Tokyo (JP); Fumitaka HIRAKO, Tokyo (JP); Tomohiro YAMASHITA, Tokyo (JP)

(21) Appl. No.: 17/192,922

(22) Filed: Mar. 5, 2021

(30) Foreign Application Priority Data
Jun. 22, 2020 (JP) 2020-107090

(51) Int. Cl. G02B 6/42

(52) U.S. Cl. CPC G02B 6/4244; G02B 6/4221; G02B 6/4239; G02B 6/4263

(57) ABSTRACT

A receptacle with lens can be mounted to an optimum position without monitoring an optical power. In an optical module constructed by a photonic device, a photonic device pedestal mounting the photonic device thereto, a TO-CAN stem, a cap with window glass, and a receptacle with lens, the TO-CAN stem is fitted to the receptacle with lens, the receptacle with lens is provided with a lens which can obtain a predetermined coupling efficiency between the photonic device and an optical fiber mounted to the receptacle with lens, and the TO-CAN stem is fitted with no alignment and bonded and fixed to the receptacle with lens. Therefore, the optimum mounting position of the receptacle with lens is achieved only by the mounting accuracy of the photonic device and the parts dimensional tolerances of the TO-CAN stem and the receptacle with lens without directly monitoring the optical power from the photonic device.

### TECHNICAL FIELD

The present invention relates to an optical module sending and receiving an optical signal, and a method of manufacturing the same.

### BACKGROUND ART

Various types of optical modules have been conventionally produced for an optical module used in an optical communication. This kind of optical module includes two types optical modules, that is, an optical transmitter module and an optical receiver module. Among them, the optical transmitter module is provided with a light-emitting semiconductor device (laser diode), and has a function of converting an electrical signal into an optical signal and transmitting the optical signal to an optical fiber. In the meantime, the optical receiver module is provided with a light-receiving semiconductor device (photo diode), and has a function of converting the optical signal from the optical fiber into the electrical signal.

Thus, this kind of optical module has been used in various fields such as a communication system controlling a robot in a factory, in addition to a system supporting a public network, which is provided mainly for a subscriber. In any system, a price reduction is required as a market needs. The price reduction is required in the same manner for the optical module used in the system.

FIG. 3 shows an example of an optical transmitter module as a conventional type of optical module.

The optical transmitter module is constructed by a photonic device 100 (here, a vertical resonator surface emitting laser which is a kind of laser diode: VCSEL) emitting light, a photonic device pedestal 110 mounting the photonic device 100 thereon, a TO-CAN system 120 mounting the photonic device pedestal 110 thereon, a cap with window glass 130 encapsulated in a nitrogen (N2) atmosphere for protecting the photonic device 100, and a receptacle with lens 150 formed by integrating a lens 150b and a sleeve portion 150a.

The lens 150b of the receptacle with lens 150 mentioned above employs an aspheric lens in which a curvature of a lens is specially processed, and is configured to allow the light emitted from the photonic device 100 to combine with an optical fiber 170 via an optical connector 160 inserted into the sleeve portion 150a (refer to FIG. 4).

Next, a description will be given in detail of an example of a method of assembling the optical transmitter module mentioned above by using FIG. 4.

In order to assemble the optical transmitter module, the photonic device pedestal 110 has been fixed with a silver paste to the vicinity of a center of a photonic device mounting surface 120a of a TO-CAN stem 120, and the photonic device 100 has been fixed with the silver paste onto the photonic device pedestal 110. Thereafter, for the purpose of protecting the photonic device 100, a cap with window glass 130 having a window glass 130a transmitting the light has been fixed to the photonic device mounting surface 120a under a nitrogen (N2) atmosphere.

Finally, the receptacle with lens 150 is fixed to the cap with window glass 130. However, a light output from the photonic device 100 can not be input to the optical fiber having a small core diameter between 50 and 200 μm only by simply attaching the receptacle with lens 150 to the cap with window glass 130. As a result, the optical connector 160 having the optical fiber 170 attached thereto is previously inserted into the sleeve portion 150a of the receptacle with lens 150.

Thereafter, the photonic device 100 is made to emit light by applying a predetermined electric current to the photonic device 100. In this manner, the light emitted through the window glass 130a of the cap with window glass 130 efficiently enters into the optical fiber 170, and the receptacle with lens 150 has been moved in three directions including X, Y and Z directions and aligned at a position where the light output becomes maximum, while monitoring the light output taken out of the optical fiber 170. Thereafter, the receptacle with lens 150 has been fixed to the cap with window glass 130 by curing a previously applied adhesive agent 140 such as an ultraviolet cure resin or a thermoset resin.

On the other hand, in a case where the optical module is the optical receiver module, the receptacle with lens 150 has been moved in three directions including X, Y and Z directions and aligned at an optimum position so that the light-receiving current converted by the light-receiving semiconductor device becomes maximum by the light received via the optical connector of the optical fiber. Thereafter, the receptacle with lens 150 has been fixed to the cap with window glass 130 with the adhesive agent 140 in the same manner as the optical transmitter module.

As mentioned above, the optical transmitter module and the optical receiver module according to the conventional example mentioned above both have essentially required the aligning work and system for aligning with the center of the optical axis in a state of operating the light-emitting semiconductor device or the light-receiving semiconductor device.

A description will be specifically given below of a known example of this kind of optical module.

For example, as disclosed in patent literature 1, an optical receptacle with lens exists as a prior art, the optical receptacle with lens including a rod-like lens, a cylindrical sleeve into which a front end portion of the rod-like lens is inserted and fixed from one end portion, and a front end portion of a plug ferrule having an optical fiber fixed thereto is fixed at the axial center from the other end portion is inserted, and with which the front end surface of the plug ferrule and the front end surface of the rod-like lens are brought into contact, and a tubular lens holder having a through hole and gripping a rear end portion of the rod-like lens in an inner peripheral surface of the through hole, and processing the rear end surface of the rod-like lens to a curved surface so that a light focusing point is provided at a position which is shifted from an optical fiber front end surface of the front end portion of the plug ferrule in a direction of an optical axis, and a spot size on an end surface of the optical fiber is greater than a core of the optical fiber.

### CITATION LIST

### Patent Literature

Patent Literature 1: Japanese Patent No. 4883927

### SUMMARY OF INVENTION

### Technical Problem

However, as mentioned above, the conventional optical module and method of manufacturing the same essentially requires the work and system for allowing the photonic device to emit light and aligning the receptacle with lens at the optimum position while monitoring the light output from the optical fiber, when mounting the conventional receptacle with lens, and several minutes are required for this step, thereby causing an increase in a production cost and a product cost.

Further, in the case of the patent literature 1 mentioned above, the rear end surface of the rod-like lens is processed to the curved surface so that the light focusing point is provided at the position which is shifted from the optical fiber front end surface of the front end portion of the plug ferrule in the direction of the optical axis, and the spot size on the end surface of the optical fiber is greater than the core of the optical fiber. As a result, the process of the rod-like lens is complicated. Further, there has been such a problem that a specific structure for the optical receptacle in relation to a case, a lens holder and a sleeve case of the photonic device is not disclosed.

An object of the present invention is to provide so as to allow an optical module to be assembled without aligning step and system by deleting an aligning step which is a main cause of cost increase and managing a receptacle with lens only by a dimension of a part to be assembled and a mounting accuracy, for achieving a price reduction of the optical module.

### Solution to Problem

The present invention is characterized in that a receptacle with lens is fitted into a TO-CAN stem by mounting a photonic device to the center of the TO-CAN stem at a predetermined position accuracy in an optical module constructed by a photonic device, a photonic device pedestal mounting the photonic device thereto, the TO-CAN stem, a cap with window glass and the receptacle with lens.

The receptacle with lens is provided with a lens in which a predetermined coupling efficiency with the optical fiber mounted to the photonic device and the receptacle with lens can be obtained, and is characterized in that the receptacle with lens is fitted with no alignment to the TO-CAN stem and is fixed by bonding.

The lens described above is characterized in that the coupling efficiency with the optical fiber is equal to or more than 30%.

The photonic device is characterized in that the photonic device is mounted to a photonic device mounting surface of the TO-CAN stem at a position of being equal to or less than ±30 μm with respect to the center of the optical axis on the basis of a side wall dimension of the TO-CAN stem, and a sum of dimensional tolerances of an inner wall of the receptacle with lens and a stem side wall of the TO-CAN stem is set to be equal to or less than ±50 μm.

The optical fiber positioned at the center of the optical connector mounted to the receptacle with lens is a hard plastic clad fiber having a core diameter of ϕ200 μm or a plastic optical fiber having a core diameter of ϕ980 μm.

The present invention provides a method of manufacturing an optical module constructed by a photonic device, a photonic device pedestal mounting the photonic device thereto, a TO-CAN stem, a cap with window glass, and a receptacle with lens, characterized by comprising a step of mounting the photonic device pedestal to the vicinity of a photonic device mounting surface of the TO-CAN stem, a step of recognizing a stem side wall of the TO-CAN stem mounting the photonic device thereto by an image camera and determining the center of the photonic device mounting surface, thereby mounting the photonic device to the photonic device mounting surface at a position of being away from the center at a predetermined position, a step of mounting the cap with window glass to the photonic device mounting surface of the TO-CAN stem, and a step of fitting an inner wall of a receptacle with lens previously manufactured at a predetermined dimensional tolerance accuracy and the side wall of the TO-CAN stem, and curing and fixing with an adhesive agent of an ultraviolet cure resin or a thermoset resin.

The mounting accuracy of the photonic device described above is set to be equal to or less than ±30 μm from the center of the TO-CAN stem.

The dimensional tolerance of the inner wall of the receptacle with lens and the side wall of the TO-CAN stem described above is equal to or less than ±50 μm.

### Effect of Invention

According to the optical module and the method of manufacturing the same of the present invention, the optical module having a predetermined light output can be achieved only by fitting the receptacle with lens to the TO-CAN stem since the TO-CAN stem and the receptacle with lens previously manufactured at the predetermined tolerance is used, and the photonic device is mounted to the center of the TO-CAN stem at the predetermined position accuracy.

Therefore, the conventionally essential aligning step and system are not required by applying the present invention, thereby can provide the optical transmitter module having a low price.

### BRIEF DESCRIPTION OF DRAWINGS

FIG. 1 is a view showing an optical module according to an embodiment of the present invention.

FIG. 2 is a view describing an assembling procedure (a manufacturing method) of the optical module according to the present invention.

FIG. 3 is a view showing a conventional optical module.

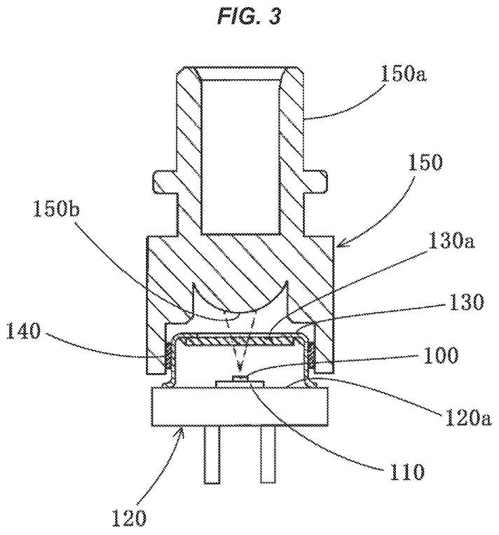

FIG. 4 is a view describing an assembling procedure (a manufacturing method) of the conventional optical module.

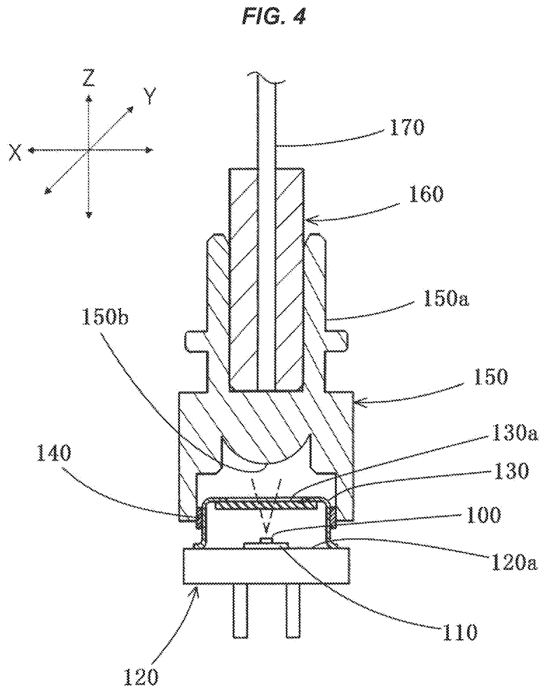

FIG. 5 is a view showing a coupling efficiency caused by a gap between a photonic device and an optical fiber.

### DESCRIPTION OF EMBODIMENTS

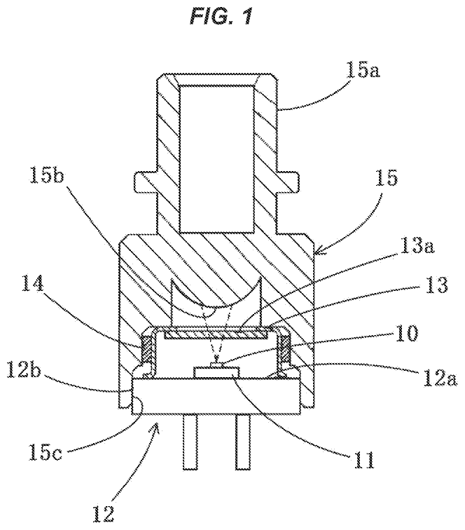

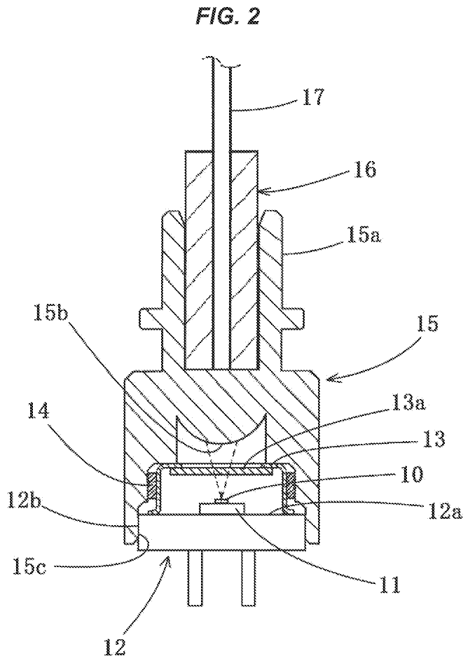

A structure of an optical module according to the present invention is shown in FIGS. 1 and 2 by exemplifying an optical transmitter module.

More specifically, as shown in FIGS. 1 and 2, the present invention is constructed by a photonic device (a vertical resonator surface emitting laser: VCSEL) 10, a pedestal 11 mounting the photonic device 10 thereto, a TO-CAN stem 12 mounting the photonic device pedestal 11 thereto, a cap with window glass 13 protecting the photonic device 10, and a receptacle with lens 15 formed by integrating an aspheric lens portion 15b and a sleeve portion 15a inserting an optical connector 16 having an optical fiber 17 in a center thereof. Here, an inner wall 15c of the receptacle with lens 15 is fitted to a side wall 12b of the TO-CAN stem 12, and is fixed to the cap with window glass 13 by an adhesive agent 14.

In the meantime, in order to achieve an optical transmitter module emitting a predetermined light output by means of the fitting of the receptacle with lens 15 to the TO-CAN stem 12 mentioned above, a mounting accuracy of the photonic device 10 mounted to the TO-CAN stem 12 and a dimensional accuracy of the receptacle with lens 15 are important.

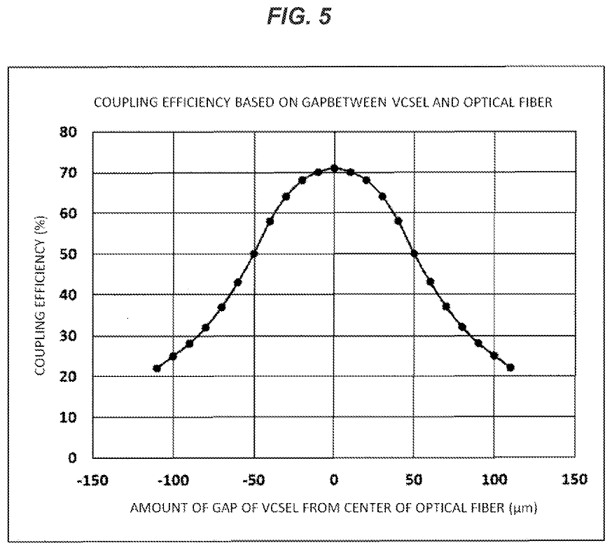

An axial gap and a coupling efficiency between the photonic device 10 and the optical fiber 17 of the optical connector 16 have been evaluated for outputting a necessary accuracy for the mounting accuracy of the photonic device and the dimensional accuracy of the receptacle with lens 15. An example of the evaluation thereof is shown in FIG. 5.

In the present example, the measurement was made by using the photonic device 10, and the optical connector 16 having at the center thereof the optical fiber 17 inserted into the sleeve portion 15a of the receptacle with lens 15 and having a core diameter ϕ200 μm.

As shown in FIG. 5, a horizontal axis indicates an amount of position gap (μm) in X and Y directions between the photonic device 10 and the fiber 17 positioned at the center of the optical connector 16 and having a core diameter ϕ200 μm, and a vertical axis indicates what rate of the light emitted from the photonic device 10 enters into the optical fiber 17 having the core diameter ϕ200 μm. This is generally called as a coupling efficiency.

Here, it is known that the greater the position gap between the photonic device 10 and the optical fiber 17 is, the smaller an optical power coupled to the optical fiber 17 is. For example, in a case where 30% or more of the light output of the photonic device 10 is taken into the optical fiber 17 having the core diameter ϕ200 μm, it is necessary to suppress the amount of position gap between the photonic device 10 and the optical fiber 17 to ±80 μm or less. On the basis of this result, the optical module can be easily and rapidly assembled while deleting the aligning step and system which have been conventionally essential, as long as the mounting gap between the photonic device 10 and the optical fiber 17 can be suppressed to ±80 μm or less by performing a dimensional management of the constructing parts.

In the present embodiment, in order to suppress the mounting gap between the photonic device 10 and the optical fiber 17 to ±80 μm or less, an amount of gap of the photonic device 10 from the center of the photonic device mounting surface of the TO-CAN stem 12 is set to be equal to or less than ±30 μm. Further, a sum of the dimensional tolerances of the inner wall 15c of the receptacle with lens 15 and the stem side wall 12b of the TO-CAN stem 12 is set to be equal to or less than ±50 μm.

Next, a description will be given in detail of an assembling procedure (a manufacturing method) of the optical module according to the present embodiment with reference to FIG. 2.

The photonic device pedestal 11 is mounted to the vicinity of the center of the photonic device mounting surface 12a of the TO-CAN stem 12 with a silver paste. Next, the photonic device (vertical resonator surface emitting laser: VCSEL) 10 is mounted to the photonic device mounting surface 12a at a position which is ±30 μm or less away from the center, by recognizing the stem side wall 12b of the TO-CAN stem 12 by an image camera, and determining the center of the photonic device mounting surface 12a.

Next, for the purpose of protecting the photonic device 10, the cap with window glass 13 is mounted to the photonic device mounting surface 12a of the TO-CAN stem 12. Finally, the side wall 12b of the TO-CAN stem 12 is fitted to the inner wall 15c of the receptacle with lens 15 previously manufactured at a totally ±50 μm or less dimensional tolerance accuracy, and is thereafter cured and fixed by the adhesive agent 14 such as the ultraviolet cure resin or the thermoset resin.

The present embodiment exemplifies a case where the applied optical fiber 17 is the hard plastic clad fiber having the core diameter of ϕ200 μm, and the maximum value of the amount of gap is set to ±80 μm on the basis of an allowable mounting tolerance thereof. However, the present invention is not limited to this, but the optical fiber may be a plastic optical fiber, for example, having a core diameter of ϕ980 μm. Since the required tolerance varies due to the core diameter of the applied optical fiber 17 and the used optical power, the mounting accuracy of the photonic device 10 and the dimensional accuracies of the TO-CAN stem 12 and the receptacle with lens 15 are determined along therewith.

In the meantime, in a case of the optical receiver module, the mounting accuracy of the light-receiving semiconductor device and the dimensional tolerance accuracies of the parts are decided by previously comprehending the tolerance between the optical fiber and the light-receiving semiconductor device and setting the tolerance to an allowable tolerance thereof or less, in the same manner.

1. An optical module comprising:
a photonic device;
a photonic device pedestal mounting the photonic device thereto;
a TO-CAN stem;
a cap with window glass; and
a receptacle with lens,
wherein the receptacle with lens is fitted into the TO-CAN stem by mounting the photonic device to the center of the TO-CAN stem at a predetermined position accuracy.

2. The optical module according to claim 1, wherein the receptacle with lens is provided with a lens in which a predetermined coupling efficiency with the optical fiber mounted to the photonic device and the receptacle with lens can be obtained, and the receptacle with lens is fitted with no alignment to the TO-CAN stem and is fixed by bonding.

3. The optical module according to claim 2, wherein the coupling efficiency of the lens with the optical fiber is equal to or more than 30%.

4. The optical module according to claim 1, wherein the photonic device is mounted to a photonic device mounting surface of the TO-CAN stem at a position of being ±30 μm with respect to the center of the optical axis on the basis of a side wall dimension of the TO-CAN stem, and a sum of dimensional tolerances of an inner wall of the receptacle with lens and a stem side wall of the TO-CAN stem is set to be equal to or less than ±50 μm.

5. The optical module according to claim 1, wherein the optical fiber positioned at the center of the optical connector mounted to the receptacle with lens is a hard plastic clad fiber having a core diameter of ϕ3200 μm or a plastic optical fiber having a core diameter of ϕ980 μm.

6. The optical module according to claim 2, wherein the optical fiber positioned at the center of the optical connector mounted to the receptacle with lens is a hard plastic clad fiber having a core diameter of ϕ200 μm or a plastic optical fiber having a core diameter of ϕ980 μm.

7. A method of manufacturing an optical module including a photonic device, a photonic device pedestal mounting the photonic device thereto, a TO-CAN stem, a cap with window glass, and a receptacle with lens, the method comprising:
a step of mounting the photonic device pedestal to the vicinity of a photonic device mounting surface of the TO-CAN stem;
a step of recognizing a stem side wall of the TO-CAN stem mounting the photonic device thereto by an image camera and determining the center of the photonic device mounting surface, thereby mounting the photonic device to the photonic device mounting surface at a position of being away from the center at a predetermined position;
a step of mounting the cap with window glass to the photonic device mounting surface of the TO-CAN stem; and
a step of fitting an inner wall of a receptacle with lens previously manufactured at a predetermined dimensional tolerance accuracy and the side wall of the TO-CAN stem, and curing and fixing with an adhesive agent of an ultraviolet cure resin or a thermoset resin.

8. The method of manufacturing the optical module according to claim 7, wherein the mounting accuracy of the photonic device is set to be equal to or less than ±30 μm from the center of the TO-CAN stem.

9. The method of manufacturing the optical module according to claim 7, wherein the dimensional tolerance of the inner wall of the receptacle with lens and the side wall of the TO-CAN stem is equal to or less than ±50 μm.
